(19) United States
(12) Patent Application Publication
(10) Pub. No.: US 2010/0268757 A1
(43) Pub. Date: Oct. 21, 2010

(54) Pseudo Pipelining of Client Requests

(75) Inventor: Darin FISHER, San Carlos, CA (US)

Correspondence Address: STERNE, KESSLER, GOLDSTEIN & FOX, P.L.L.C., 1100 NEW YORK AVENUE, N.W., WASHINGTON, DC, 20005, US

(73) Assignee: Google Inc., Mountain View, CA (US)

(21) Appl. No.: 12/425,889

(22) Filed: Apr. 17, 2009

(51) Int. Cl. G06F 15/16

(52) U.S. Cl. 709/203; 709/224

(57) ABSTRACT

Methods and systems for a client such as a web browser to access the services of a server such as a web server are disclosed. In one embodiment, a method implemented by a client to transmit service requests to a server includes, transmitting a first service request over a persistent-connection to the server, detecting a beginning of a response to the first service request from the server, and transmitting a second service request to the server after the beginning of the response is detected. The client can be a web browser, and the server can be a web server. The first and second service requests, as well as the response to the first service requests may be transmitted over a persistent connection.

### BACKGROUND

1. Technical Field

The present invention relates to communication between a client device and a server.

2. Background Art

The Internet and the World Wide Web (WWW) are used by numerous persons to access information and other content. Governments, businesses, educational institutions, news outlets, entertainment outlets, individuals, and other entities, place increasing amounts of content on servers that are accessible from throughout the world through the WWW. The Internet, which connects numerous networks, provides the worldwide communication connectivity. The WWW, also known as the “web,” provides the protocol framework that enables users to access content available on servers connected to the web (web servers). Users access the web through client devices using a client application such as a web browser. A web browser, for example, can access content through one or more web pages residing on, or accessible to, a web server.

The Hypertext Transfer Protocol (HTTP) is a protocol that defines the message exchange between a web browser and a web server. A HTTP protocol is, for example, defined in RFC 2616 “Hypertext Transfer Protocol—HTTP/1.1,” published by the Internet Engineering Task Force (IETF) in June 1999. A web page can be defined using Hypertext Markup Language (HTML). A HTML is defined, for example, in RFC 1866 “Hypertext Markup Language-2.0,” published by the IETF in November 1995. When a client web browser needs to access information on a web server, it accesses a web page on that web server, by invoking a uniform resource locator (URL). A URL can be considered an address for web content including web pages.

A web page can include text, images, audio, video, and other content. Typically, the content available on a web page is accessible as several separate objects. For example, when a web page is first accessed the text may be available for the client to display first before any image or video content is available. In general, upon initially accessing a web page, a web browser receives a HTML specification of that web page from the web server. The received HTML specification may include the URLs for one or more embedded elements of web content. The web browser then separately retrieves each of the embedded elements. Typically, the web browser transmits multiple messages (referred to as service requests) to the web server, in order to access all of the content embedded in a web page. The messages exchanged between the web browser and the web server can be HTTP messages (i.e., messages formatted and processed in accordance with the HTTP protocol).

Having to access and retrieve multiple data components from one or more web servers in order to display a web page often delays the displaying of web pages. For example, each service request can incur a delay that includes the time taken for a service request to go from the web browser to the web server, the processing time for the web server to generate the response to the service request, and the time taken for the response to reach the web browser from the web server. When sequentially transmitting service requests, such that only one service request from the web browser is pending at a time, the delay involved in completely displaying the content of a web page with many embedded components can be substantial, because each of the embedded components would require a separate service request.

In conventional systems, several techniques are used to decrease the delay involved when a web browser retrieves multiple data components from a web server. Persistent connections between the web browser and the web server, and pipelining of requests from the web browser are two such techniques. Persistent connections are connections over which multiple requests and responses can be exchanged between the web browser and web server, without having to separately establish connections for each request. Persistent connections decrease the delay involved in retrieving multiple data components from the server, by reducing new connections required between the same web browser and web server. Pipelining enables the web browser to transmit multiple service requests to the web server without waiting for completion of processing of previous requests. Pipelining reduces the delay involved in accessing multiple data components by reducing the time that the server waits in between service requests. However, in many instances, when a web server does not support pipelining, or inadequately supports pipelining, web browsers communicating with that server may experience performance deterioration.

### SUMMARY

In embodiments of the present invention, methods and systems for a client such as a web browser to access the services of a server such as a web server are disclosed. In one embodiment, a method implemented by a client to transmit service requests to a server includes, transmitting a first service request over a persistent-connection to the server, detecting a beginning of a response to the first service request from the server, and transmitting a second service request to the server after the beginning of the response is detected. The client can be a web browser, and the server can be a web server. The first and second service requests, as well as the response to the first service requests may be transmitted over a persistent connection.

Another embodiment is a client device that includes at least one processor, a memory, and a browser coupled to the memory and the at least one processor. The browser includes a pseudo pipelining controller module configured to transmit a first service request to a server over a persistent-connection, to detect a beginning of a first response from the server, and to transmit a second service request over the persistent-connection to the server after the beginning of the first response is detected.

Yet another embodiment is a computer program product including a computer readable medium having computer program logic recorded thereon for causing at least one processor to transmit service requests to a server. The computer program logic includes a first program logic, a second program logic, and a third program logic. The first program logic causes the at least one processor to transmit a first service request to the server over a persistent-connection. The second program logic causes the at least one processor to detect a beginning of a first response from the server, where the first response is associated with the first service request. The third program logic causes the at least one processor to transmit a second service request to the server over the persistent-connection after the beginning of the first response is detected.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

Reference will be made to the embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a system having a client and a server, according to an embodiment of the present invention.

FIG. 2 illustrates a client device, according to an embodiment of the present invention.

FIG. 3 illustrates a process to generate service requests, according to an embodiment of the present invention.

FIG. 4 illustrates a process for transmitting service requests, according to an embodiment of the present invention.

FIG. 5 illustrates a process for detecting incoming responses, according to an embodiment of the present invention.

### DETAILED DESCRIPTION

While the present invention is described herein with reference to illustrative embodiments for particular applications, it should be understood that the invention is not limited thereto. Those skilled in the art with access to the teachings herein will recognize additional modifications, applications, and embodiments within the scope thereof and additional fields in which the invention would be of significant utility.

### Overview

The present invention includes methods and systems for improving the performance of client-server systems. In one embodiment, a web client, such as a web browser, implements an improved pipelining technique to transmit service requests to a web server. With the growing complexity of web pages, particularly in terms of separately embedded content, efficient pipelining can be a significant factor in improving the performance of web interactions. However, it is often the case that web servers do not properly implement some features such as support for service request pipelining by clients. The service request pipelining methods described herein can be an improvement over aspects of the conventional HTTP protocol. The improvements disclosed herein can enable web clients to interact with web servers including those that do not fully support pipelining of service requests.

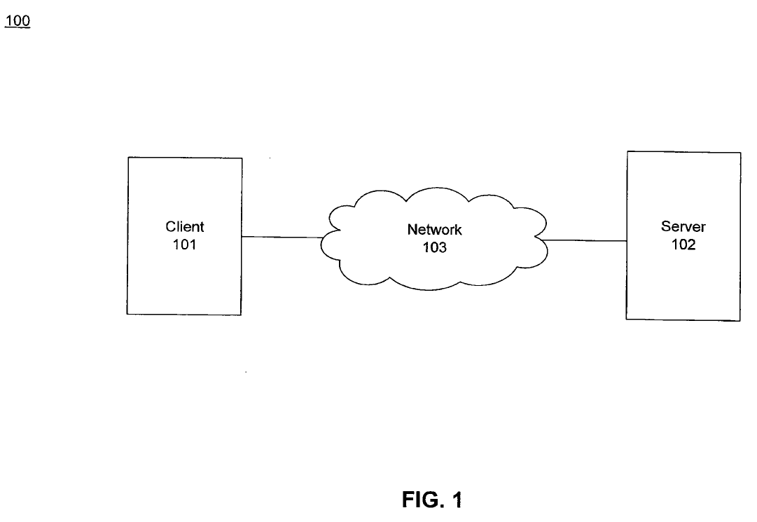

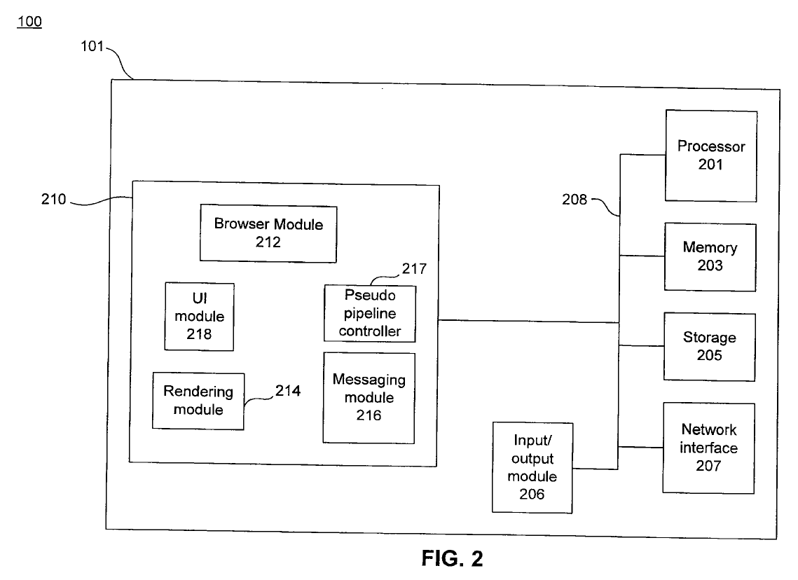

FIG. 1 shows a system 100, according to an embodiment of the present invention, in which a client 101 accesses a server 102 through one or more networks 103. Client 101 can include a client application such as a web browser. In some embodiments, the present invention can include a conventional web browser modified according to the teachings in this disclosure. Example conventional web browsers include Chrome browser from Google Inc., Firefox browser from Mozilla Corporation, and the like. Client 101 can be a device that includes at least one processor, at least one memory, and at least one network interface. For example, client 101 can be implemented on a personal computer, handheld computer, personal digital assistant, a mobile telephone, a game console, digital entertainment system, set-top box, and the like. FIG. 2 illustrates client 101 in more detail, according to an embodiment of the present invention.

Server 102 can include a web server such as the Google Web Server from Google Inc., Apache Web Server from the Apache foundation, Internet Information Services from Microsoft, and the like. Server 102 can provide access to web content stored locally on server 102 or coupled storage devices (not shown). Server 102 typically includes at least one server computer connected to a network. Example server computers include but are not limited to, a computer, workstation, distributed computing system, computer cluster, embedded system, stand-alone electronic device, networked device, mobile device (e.g. mobile phone or mobile computing device), rack server, set-top box, or other type of computer system having at least one processor, memory, and network interface.

Network 103 includes one or more networks, such as the Internet. In some examples, network 103 can include one or more wide area networks (WAN) or local area networks (LAN). Network 103 can include one or more network technologies such as Ethernet, Fast Ethernet, Gigabit Ethernet, a variant of IEEE 802.11 such as WIFI, and the like.

In an example embodiment, network 103, client 101, and server 102, use the Internet Protocol (IP, e.g., IP version 6 or IP version 4) as the network communication protocol. Client 101 and server 102 can implement Transmission Control Protocol (TCP) as a transport protocol, and Hypertext Transfer Protocol (HTTP) as a higher layer protocol. For example, according to the TCP/IP Protocol Reference model HTTP may be an application layer protocol, TCP may be a transport layer protocol, and IP may be the network layer protocol. These examples are illustrative and not intended to limit the present invention.

FIG. 2 illustrates client 101 that includes a web browser 210, according to an embodiment of the present invention. Client 101 includes a processor 201, a memory 203, a storage 205, an input/output module 206, a network interface 207, communication infrastructure 208, and web browser 210. Persons skilled in the art would understand that client 101 can include other components than those noted above.

Processor 201 can include one or more commercially available processors such as those available from Intel or AMD, or custom processors such as field programmable gate arrays (FPGA), digital signal processors (DSP), and application specific integrated circuits (ASIC). Processor 201 controls the operation of components and/or modules of client 101 and may execute processing logic implementing web browser 210. Memory 203 can include one or more of a volatile memory such as dynamic random access memory (DRAM), a static random access memory (SRAM), and the like. Storage 205 can include one or more non-volatile digital storage devices such as hard disk drive, flash memory device, and the like.

Input/output interface 206 includes one or more interfaces connecting client 101 to user input/output devices such as keyboard, mouse, display or touchscreen. For example, user input can be provided through a keyboard and mouse connected through input/output interface 206. The output of client 101, such as web pages displayed in web browser 210, can be output to a display through input/output interface 206. Network interface 207 provides client 101 with communication connectivity to network 103, and can include, but is not limited to, an Ethernet interface or a WIFI interface. Communication infrastructure 208 communicatively couples processor 201 to other components and modules of client 101. Communication infrastructure 208 can include, but is not limited to, a Peripheral Component Interconnect (PC) bus, Advanced Microcontroller Bus Architecture (AMBA) bus, Industry Standard Architecture (ISA) bus, or the like.

Web browser 210 includes the functionality of a client that accesses web content on one or more web servers 102, according to embodiments of this invention. Web browser 210 can be implemented in software, firmware, hardware, or using a combination thereof. Web browser 210 can include a browser module 212, a renderer module 214, a messaging module 216, a pseudo pipeline controller 217, and a user interface module 218. In one embodiment, the processing logic of web browser 210 is implemented using one or more programming languages and scripting languages such as C++, Java, HTML, XML, and JavaScript.

Browser module 212 includes functionality to coordinate the actions and processing of web browser 210. Browser module 212, for example, can access web content based on user input received from user interface module 218. Browser module 212 can implement one or more methods of accessing web content, such as HTTP, File Transfer Protocol (FTP), or Telnet. Browser module 212 can send the corresponding messages through messaging module 216 to one or more web servers, and receive the requested content in response through messaging module 216 and pseudo pipeline controller 217. The received content can then be interpreted using renderer module 214 for display in the browser module 212. Browser module 212 can also include the functionality to display received web content in one or more tabs, frames, and/or windows. For example, browser module 212 can display incoming web content in a separate window or tab based on a configuration setting provided by the user.

Renderer module 214 includes functionality to interpret the web pages and other received web content for display in the browser module 212. For example, renderer module 214 can take web content received by browser module 212 as input, and perform interpretation and/or handling of that content for display in the environment of client 101. Renderer module can implement, for example, interpretation of text tags, such as HTML tags, that can be embedded in the web content received. In some embodiments, renderer module 214 can include and/or invoke helper applications and plug-in modules for processing content. Helper applications, for example, can be used to access content based on filename extensions of that content, such as for audio files, compressed files, etc. Plug-in applications, for example, can be used to access and display data in formats such as Portable Document Format (PDF), FLASH multimedia, etc. In some embodiments, renderer module 216 can indicate to browser module 212 whether the content should be displayed in a separate tab, frame, or window.

Messaging module 216 includes the functionality to generate and transmit HTTP messages, and to receive HTTP messages from/to web servers. In an embodiment, messaging module 216 can set up and maintain persistent connections (persistent connections are described below) to one or more servers to access web content required by browser module 212. Messaging module 216 can also generate and transmit messages according to formats required by HTTP, FTP, or other such protocol, to access web content. Received messages, corresponding to various protocol formats such as HTTP and FTP, can also be processed by messaging module 216, for example, to extract web content in those messages. The web content can then be passed on to browser module 212 and/or to renderer module 214 for interpretation and display.

Pseudo pipeline controller 217, together with messaging module 216, controls the transmission of service requests and receiving of responses from servers. Pseudo pipeline controller 217 includes the functionality to monitor one or more persistent connections for incoming response messages from a server, according to embodiments of the present invention. For example, upon when a service request has been transmitted to a web server, pseudo pipeline controller 217 can monitor a persistent connection to detect the corresponding response from the web server. Upon detection of the incoming response, for example, pseudo pipeline controller 217 can cause the transmission of another service request to the web server.

User interface module 218 includes the functionality to capture user input and, for example, to send the captured user input to browser module 212. For example, user interface module 218 can receive user input from through input/output module 206 from a keyboard, mouse, touchscreen, or other input device.

A person of ordinary skill in the art would understand that web browser 210, its modules 212-218, and any additional modules chosen to add various functionalities to web browser 210 can be implemented according to various implementation models. For example, web browser 210 can be a single operating system process or may comprise of multiple operating system processes and/or threads. In one example embodiment, each tab in web browser 210 can be a browser module 212 implemented as a separate process. Browser module 212 can include a thread that implements user interface module 218. Browser module 212 can communicate with renderer module 214 and messaging module 214 both implemented as separate processes. Renderer module 214 can, for example, communicate with one or more browser module 214 processes, each one corresponding to a separate tab in web browser 210. Pseudo pipeline controller 217 can be implemented as a separate thread within the process that implements messaging module 216. Implementing modules 212-218 as separate threads and/or processes can include advantages such as substantially isolating performance impediments in accessing content on one server, from the rest of the web browsers activities. The described implementation is only for illustrative purposes, and is not intended to limit the present invention. An example browser is described in U.S. Patent Application No. 61/052,719 “Multi-Process Browser Architecture” filed on May 13, 2008.

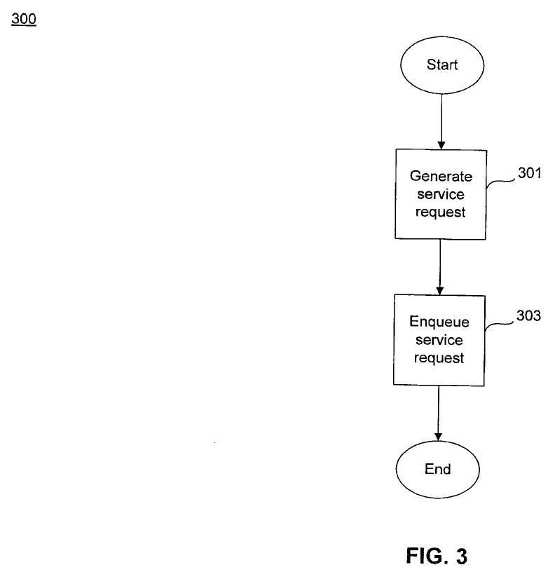

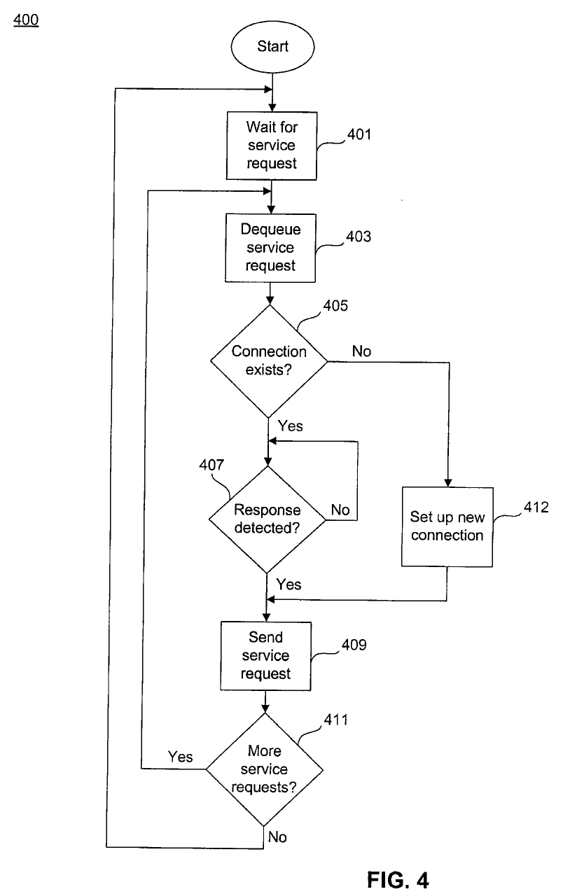

FIGS. 3-4 illustrate the processing involved in accessing web content between a client and a server according to an embodiment of the present invention. FIG. 3 illustrates processing steps 301-302, that are involved in generating service requests in a client application such as web browser 210. Process 300 (steps 301-302), in one embodiment, can be executed by browser module 212, messaging module 216, and pseudo pipeline controller 217. For example, in step 301, a service request can be generated by browser module 212. A service request can be, for example, a request for web content. A service request can be an HTTP request, a FTP request, or a Telnet request, based on characteristics of the web content to be accessed, and capabilities of web browser 210 and the corresponding web server. An HTTP service request can be generated to retrieve a web page based on a URL specified by a user, or to retrieve web content embedded in or linked from a web page that is being parsed by browser module 212. An FTP service request can be generated to retrieve a file, such as a video file, that has been embedded or linked from a web page already being parsed by browser module 212, or based on user input. Typically, each service request is formatted into a message corresponding to a predetermined format, including a predetermined message header structure according to the type of service request. For example, some formats for HTTP messages are defined in RFC 2616, and client 101 and server 102 can format their HTTP messages accordingly. In some embodiments, changes to the basic formats defined in the RFC 2616 can be enabled by ensuring that clients and corresponding servers, sending and/or receiving messages with such modified formats, can recognize and appropriately process such modifications. In one embodiment, browser module 212 may send the request (e.g., the URL) including the type of access required (e.g., HTTP, FTP) to messaging module 216. Messaging module 216 can generate a message having the appropriate format including properly formatted headers.

In step 303, the generated service request is enqueued before transmission to the web server. In one embodiment, messaging module 216, having generated a service request according to a request from browser module 212, can input the generated message in an outgoing queue. Queuing of service requests allows the process that generates a service request to continue with its processing without waiting for the service request to be transmitted out of the client. Various methods of creating and maintaining queues of messages are well known. It should be noted that any data structure in which multiple service requests can be stored and subsequently extracted from can be used instead of a queue. In one embodiment, HTTP service requests generated and formatted by messaging module 216, are enqueued in a queue data structure implemented in memory 203. Having enqueued the generated service request, messaging module 216 and browser module 212 can continue with other processing tasks. A person of skill in the art will understand that queues in the processing of messages can be implemented using various well-known methods, and each such method can have advantages and disadvantages based on the implementation model used for web browser 210. For example, if web browser 210 is implemented as a single process, the implications and advantages of queuing, like in step 303, can be different from when web browser 210 is implemented such that browser module 212 and messaging module 216 are different processes.

FIG. 4 illustrates a process 400 (steps 401-412) that can be implemented to process service requests that are already enqueued, according to an embodiment of the present invention. Process 400 can, for example, be implemented in messaging module 216 and pseudo pipeline controller 217. For example, messaging module 216 can implement steps 401-405 and 409-412, and pseudo pipeline controller 217 can implement step 407 to monitor persistent connections and to trigger transmission of service requests.

In step 401, process 400 waits for a service request. In one embodiment, waiting for a service request can involve waiting for a HTTP service request to be enqueued in a predetermined queue by another process, such as process 300 and/or browser module 212. Methods of monitoring for queue input are well-known in the art.

In step 403, a service request can be dequeued from a queue. A service request can be dequeued from a queue based on various criteria such as first in first out (FIFO), last in first out (LIFO), or some other method in which certain types of requests are dequeued ahead of others. Methods of selecting the service request to be dequeued are well-known. In general, a service request is dequeued when the system is ready to process that request. Here, process 400 dequeues a service request when it is ready to transmit that service request to a web server.

In step 405, process 400 checks if a connection exists to the web server to which the dequeued service request is to be sent. If a connection does not exist, then processing proceeds to step 412 where a new connection is setup. If a connection already exists to the web server to which the dequeued service request is to be sent then processing proceeds to step 407. A connection is a logical association established by a protocol such as TCP, between a client application such as a web browser and a web server. TCP connections are well-known in the art. A TCP connection, for example, can be represented using the IP addresses of the respective client and server, as well as some form of identifiers (also called ports) for the respective client application and web server. According to an embodiment, the connection between web browser 210 and the web server can be a persistent connection. A persistent connection can be established using the TCP protocol. Also, a persistent connection is used to exchange one or more messages between web browser 210 and web server. Persistent connections are described in greater detail in RFC 2616.

In step 407, the connection between the web browser 210 and web server is monitored to detect the receipt of the response to the last sent service request to that web server. In one embodiment, a separate monitoring thread can be monitoring the connection for the receipt of responses from the web server. Process 400 can query the monitoring thread to determine if the response to the last transmitted service request has been received. In another embodiment, the monitoring thread can update a memory location, such as a register, to indicate the last received response from the web server.

According to embodiments of the present invention, the next service request can be transmitted when at least a partial response for the last transmitted request is detected. Therefore, the monitoring in step 407 can be for purposes of detecting at least a partial response satisfying certain predetermined criteria. In one embodiment, the criteria for a partial response are satisfied when a complete header or sequence of headers of a response is received. For example, a HTTP response can include a status, one or more general headers, and one or more response headers that precede the response content. Depending on the implementation, the status, general headers and response headers may or may not appear in the sequence indicated. However, in one embodiment, the monitoring step 407 would consider a partial response having being received when it detects a signal in the incoming message or messages that the end of the response headers has been received. Web browser 210 may expect that the end of the response headers include two successive line breaks, and may detect the end of the response header when two successive line breaks in the incoming stream if text. For example, RFC 2616 specifies encodings that can be employed between a web browser and a web server in exchanging HTTP messages.

Detecting a partial response, or specifically, detecting the status and the response headers transmitted by the web server, enables the client 101 and/or web browser 210 to determine how the web server is handling the last transmitted service request. For example, the status code can indicate factors such as whether the server successfully interpreted the request and/or whether the requested web content is accessible. General headers can indicate such factors as the encoding used in the response. Response headers can include other factors including is the web browser is being redirected to another server for the requested content and other implementation specific information. In general, the status and header information is of fixed format and size. However, the web content that is returned may be large and/or may require processing in the server. Therefore, having the entire response received at the web browser before any further requests are transmitted, can cause a substantial delays the display of web pages.

Having process 400 proceed with transmitting the next request when a partial response is detected, according to an embodiment as described above, enables the web browser to keep the processing pipeline of the web server substantially occupied while at the same time ensuring that the web browser can react in a timely manner to conditions at the web server that can affect the retrieval of web content. Pipelining of requests without detecting a partial response can lead to degradation of performance in many scenarios. For example, as noted above, although the client implements service request pipelining, it is possible, and has been observed to be the case, that not every web server that interacts with that client would implement support for service request pipelining. Therefore, if the client pipelines all of its requests in parsing a web page, the server may not be able to properly handle such pipelined requests. When the web server cannot handle pipelined service requests, it may drop or discard one or more of the service requests received, leading to performance degradation. In another scenario, the transmission of pipelined requests to the server without flow control, such as that implemented in embodiments of the present invention, can lead to the request buffers at the server overflowing and one or more requests being discarded. Embodiments of the present invention, by detecting at least the receipt of a partial response to the last transmitted request, enables a web browser to manage its request pipeline in a manner that reduces the overall delay (latency) in receiving web content while simultaneously ensuring that the web browser can appropriately respond to certain server conditions.

When it is determined, in step 407, that at least a partial response to the last transmitted request has been received, processing proceeds to step 409. In step 409, the service request dequeued in step 403 is transmitted to the web server over the connection identified in step 405. Note that the service request was previously enqueued in a format corresponding the protocol being used, such as HTTP. Step 409 can perform any additions and/or modifications (e.g., update timestamp, connection identifier, etc.) to the formatted service request before transmission. Subsequently, step 409 can invoke lower protocol layer message transmission functions to send the service request to the web server.

If no corresponding connection is located in step 405, then a new connection is setup in step 412. The service request dequeued in step 403 would subsequently be transmitted over the new connection setup in step 412. As noted above, a web browser and a web server can establish a connection to reduce the delay associated with transferring web content between them. For example, RFC 2616 specifies a persistent-connection that should be setup between a web browser and web server prior to the exchange of requests and responses.

In an embodiment, a connection between the web browser and web server can be established using an exchange of HTTP messages. A connection, as used herein, is a coordinated state maintained by the web browser and the web server that describes the communication between them. A connection is, in general, setup subsequent to explicit signaling (exchange of messages) between the web browser and the web server. A connection is removed (or torn-down) also by explicit signaling between the two parties to the connection. In some instances, one side can unilaterally remove the connection, for example, such as when a connection has been inactive for a predetermined time or when the other party does not respond to messages on the connection. Underlying the HTTP messages, the web browser and the web server may use a protocol such as TCP to create the connection. TCP is a well known protocol for connection-oriented exchanges between two applications. However, it should be noted that some embodiments may use other underlying protocol mechanisms, for example, User Datagram Protocol (UDP), to create and maintain logical connections between the web browser and the web server. In an embodiment, persistent-connections as described in RFC 2616 can be used between web browser 210 and web server. Step 412, therefore can involve the exchange of one or more messages with the web server to establish a connection.

Having established a new connection to the web server, the message dequeued in step 403 is transmitted to the web server over the new connection in step 409.

In step 411, it is determined whether more service requests are already enqueued. If there are enqueued requests, than processing returns to step 403. If there are no enqueued requests, processing returns to step 401, to wait for newly generated service requests, for example, from browser module 212.

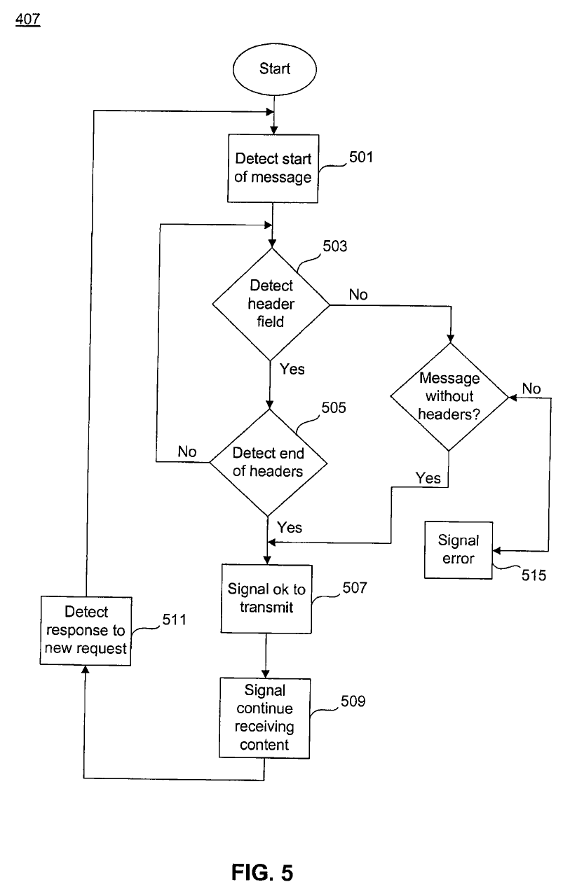

FIG. 5 illustrates process 407 in more detail, according to an embodiment. In step 501, a monitoring thread that monitors the relevant connection detects the start of a new response message. In an embodiment, HTTP response messages received over the connection can correspond to a format described in RFC 2616. According to the RFC 2616, the response message can consist of a status, zero or more response header fields, an empty line (i.e., a line with nothing preceding the carriage return line feed) indicating the end of the header fields, and possibly a message-body.

In step 503, the fields of the incoming message are monitored for response header fields. Response header fields can be determined by the field values and formats employed, such as those described in RFC 2616.

If no header fields are detected, in step 505 it is determined if the last response header field has been detected. For example, in an HTTP message according to RFC 2616, the end of the response headers can be detected when a line with nothing preceding the carriage return line feed or two successive carriage return line feeds are detected.

If in step 505, the end of the response headers is not detected, then processing returns to step 503 to process the next field. If in step 505, it is determined that the end of the response headers is detected, then processing proceeds to step 507.

In step 507, the monitoring thread may indicate that the next service request can be transmitted to the web server. For example, reaching step 507 can be indicative of a partial response to the last transmitted service request being received.

In one embodiment, in step 509, a thread can be spawned to continue the receiving of the web content of the response message. The spawned thread can continue receiving the data without affecting the pipelining of the service requests between the web server and the web browser.

In step 511, the monitoring thread can configure itself to monitor the connection for the response corresponding to the next transmitted service request. Subsequently, the monitoring thread can return to step 501 to monitor for the response to the next transmitted service request.

If in step 503, it is determined that no header fields are detected in the response that is being received, then in step 513 it is determined whether the message without header fields is a valid message. For example, some messages may be considered valid if they have only a status field with a valid value preceding the web content (e.g., a valid status field followed by two successive carriage return line feeds). If the message is considered valid in step 513, then processing proceeds to step 507.

If it is determined in step 513, that the message is not a valid response, then processing can proceed to step 515 in which browser module 212 and/or messaging module 216 can be informed of the error condition such that the appropriate action can be taken.

### CONCLUSION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It should be noted that the implementation of the various embodiments of this invention can be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools). This computer readable code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and intranets.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for a client to transmit service requests to a server, the method comprising:
transmitting a first service request to the server, wherein the first service request is transmitted over a persistent-connection;
detecting a beginning of a first response from the server, wherein the first response is associated with the first service request; and
transmitting a second service request to the server after the beginning of the first response is detected, wherein the second service request is transmitted over the persistent-connection.

2. The method of claim 1, wherein the first response from the server is received on the persistent-connection.

3. The method of claim 1, wherein the first service request, the first response, and the second service request are HTTP messages.

4. The method of claim 1, wherein the detecting step comprises:
monitoring the persistent-connection; and
locating a partial-response from the server, wherein the partial-response is part of the first response.

5. The method of claim 4, further comprising:
determining, based on the partial-response, that the server is active.

6. The method of claim 4, further comprising:
determining, based on the partial-response, that the persistent-connection is active.

7. The method of claim 4, wherein the locating step comprises:
identifying a beginning header of the first response; and
identifying an ending header of the first response.

8. The method of claim 1, wherein the second service request transmitting transmits the second service request before the first response is completely received.

9. A client device, comprising:
at least one processor;
a memory; and
a web browser coupled to the memory and the at least one processor, the web browser comprising a pseudo pipeline controller configured to:
transmit, using the at least one processor, a first service request to a server, wherein the first service request is transmitted over a persistent-connection;
detect, using the at least one processor, a beginning of a first response from the server, wherein the first response is associated with the first service request; and
transmit, using the at least one processor, a second service request to the server after the beginning of the first response is detected, wherein the second service request is transmitted over the persistent-connection.

10. The client device of claim 9, wherein the first service request, the first response, and the second service request are HTTP messages.

11. The client device of claim 10, wherein the second module is further configured to:
monitor the persistent-connection; and
locate a partial-response from the server, wherein the partial-response is part of the first response.

12. The client device of claim 9, wherein the second service request is transmitted before the first response is completely received.

13. A tangible computer program product comprising a computer readable medium having computer program logic recorded thereon for causing at least one processor to:
transmit a first service request to the server, wherein the first service request is transmitted over a persistent-connection;
detect a beginning of a first response from the server, wherein the first response is associated with the first service request; and
transmit a second service request to the server after the beginning of the first response is detected, wherein the second service request is transmitted over the persistent-connection.

14. The tangible computer program product of claim 13, wherein the first service request, the first response, and the second service request are HTTP messages.

15. The tangible computer program product of claim 13, wherein the second program logic further causes the at least one processor to:
monitor the persistent-connection; and
locate a partial-response from the server, wherein the partial-response is part of the first response.

16. The tangible computer program product of claim 13, wherein the second service request is transmitted before the first response is completely received.
